(19) United States
(12) Patent Application Publication
(10) Pub. No.: US 2008/0038530 A1
(43) Pub. Date: Feb. 14, 2008

(54) Extensible Multilayer Film

(76) Inventors: Renato Rimondi, Bazzano (IT); Carlo Nicoletti, Vignola (IT)

Correspondence Address: STITES & HARBISON PLLC, 1199 NORTH FAIRFAX STREET, SUITE 900, ALEXANDRIA, VA, 22314, US

(21) Appl. No.: 11/568,588

(22) PCT Filed: Apr. 14, 2005
(86) PCT No.: PCT/EP05/51648

§ 371 Date: Oct. 30, 2007

(30) Foreign Application Priority Data
May 7, 2004 (IT) GE2004A000038
Jun. 8, 2004 (IT) GE2004A000049

(51) Int. Cl. B32B 7/00; B32B 27/30; B32B 27/32

(52) U.S. Cl. 428/220; 428/98

(57) ABSTRACT

Extensible multilayer film comprising two external layers made of thermoplastic polyolefinic resins, two optional intermediate adhesive layers and one central layer; the said external layers being realized with ethylene/α-olefins copolymers resins, the said optional intermediate layers being realized with adhesive resins preferably containing linear low density polyethylene modified with polar groups, ethylene vinylacetate terpolymers, or maleic anhydride modified ethylene acrylate, the said central layer being realized with resins which impart to the film, sinergetically with the other components of the same film, the following features: glass transition temperature in a range between 20 and 70° C.; longitudinal strain greater than 200%, at a temperature comprised between 25 and 45° C., applying reduced load, less than 0.5 N/mm; necking in the range of the 40-60%; longitudinal thermo-shrinkage in the range of 40-60%; residual elastic memory, giving rise to a longitudinal force less than 0.05 N/mm when the film is subjected to a longitudinal strain≧70%; optical properties, such as: light transmission greater than 90%, opacity less than 5%, and gloss higher than 100, following to longitudinal strain.

The present invention relates to a multilayer film, particularly for the packaging of food products.

The modern distribution has progressive needs of increasing the shelf life of the fresh foods. The main request to be satisfied is the increasing of the storage time of the packaged product, so as to rationalise the shipping and to solve at least a part of the logistic and distributive problems connected with the product management. It is evident that the extension of the storage time has not to imply any loss of quality of the product; to this aim, the packaging shall perform the duty of preserving the organoleptic and chemical-physical features of the foodstuff, first of all owing to the higher awareness of the consumer, which is becoming much more careful about the healthy and qualitative aspects.

A problem having dramatic impact is related to the possibility of manufacturing, by using the same methods, that is to say the same plants, packages even of very different kind, like on one hand the films having an high gas barrier effect, and on the another hand films which allow a considerable “respiration” of the packaged product. In working with such parameters which appear completely opposed one to the other, it is evident how it is difficult to achieve good results either from the point of view of the general packaging features or of the specific features of permeability.

During the search which has led to the present invention, the common features have been searched for the different materials used; the said features allow the similar use of films having even very differing properties, particularly in respect of the gases with which they are brought in contact.

An aim of the present invention is thus to provide an extensible multilayer film which can be used by means of a single packaging technique, and which at the same time can show features which are adapted with extreme accuracy to the kind of product to be packaged.

An object of the present invention is therefore an extensible multilayer film comprising two external layers made of thermoplastic polyolefinic resins, two optional intermediate adhesive layers and one central layer;
the said external layers being realized with ethylene/α-olefins copolymers resins,
the said optional intermediate layers being realized with adhesive resins, preferably containing linear low density polyethylene modified with polar groups, terpolymers ethylene vinyl acetate, or maleic anhydride modified ethylene acrylate,
the said central layer being realized with resins which impart to the film, sinergetically with the other components of the same film, the following features:
glass transition temperature in a range between 20 and 70° C.;
longitudinal strain greater than 200%, at a temperature comprised between 25 and 45° C., applying reduced load, less than 0.5 N/mm;
necking in the range of the 40-60%, and preferably of the 45-50%;
longitudinal thermo-shrinkage in the range of 40-60%;
residual elastic memory, giving rise to a longitudinal force less than 0.05 N/mm when the film is subjected to a longitudinal strain≧70%;
optical properties, such as: light transmission greater than 90%, and preferably in the range of 93-96%; opacity less than 5%, and preferably less than 3%; and gloss higher than 100, and preferably higher than 120, following to longitudinal strain.

In the multilayer film according to the invention, which can show an overall thickness in the range of 17-60 μm so as to respond effectively to the requirements of the packaging machines, the thickness of the external layers can vary between 5 and 18 μm, the intermediate layers can vary between 2 and 5 μm, whilst the thickness of the central layer is in the range from 3 and 14 μm; the external layer which has to face the product can have a greater thickness in respect of the external layer facing the environment, and particularly can be from 30 to 50% more thick than the afore mentioned layer.

The said external layers can be realized with ethylene/α-olefins copolymer resins, preferably obtained by means of the technological process known as “metallocene” or “single site catalysis”; in case, the said resins can be admixed with ethylene/vinyl acetate copolymers, having a vinyl acetate content in the range from 5 to 14%, in an amount comprised between 0 and 40%.

In a first embodiment of the invention, the central layer comprise an ethylene/vinyl alcohol copolymer, having a content of ethylene in range from 35 to 60% mol, added with a plasticizer comprising one or more saturated aliphatic polyols having low molecular weight, that is to say a molecular weight≦500; among these saturated aliphatic polyols, 1,2-propanediol (propylene glycol), 1,2,6-esanetriol, 1,2-buthanediol, 1,5-pentanediol will be preferred. The plasticizer will be added in an amount varying from 5 to 18% by weight of the mixture with the resin.

In a second embodiment of the invention, the central layer comprise polymers or polymers blends which are adapted to respond thermally or mechanically in an almost similar way as the above described film, even if they are featuring completely different gas permeabilities, which make them available for other packaging technologies. For the above reasons polymers such as copolyamides 6/69, copolyamides 6/12, if required in mixture with ethylene/vinyl acetate copolymers (EVA having 5-28% of VA), atactic polystyrene, styrole buthadiene block copolymers (SBS) and cycloolefins (COC) if required in mixture with other polyolefins, are preferred.

Further advantages and features of the present invention will become evident from the following description of some embodiments of same, making reference to the figures of the single appended sheet of drawings, in which:

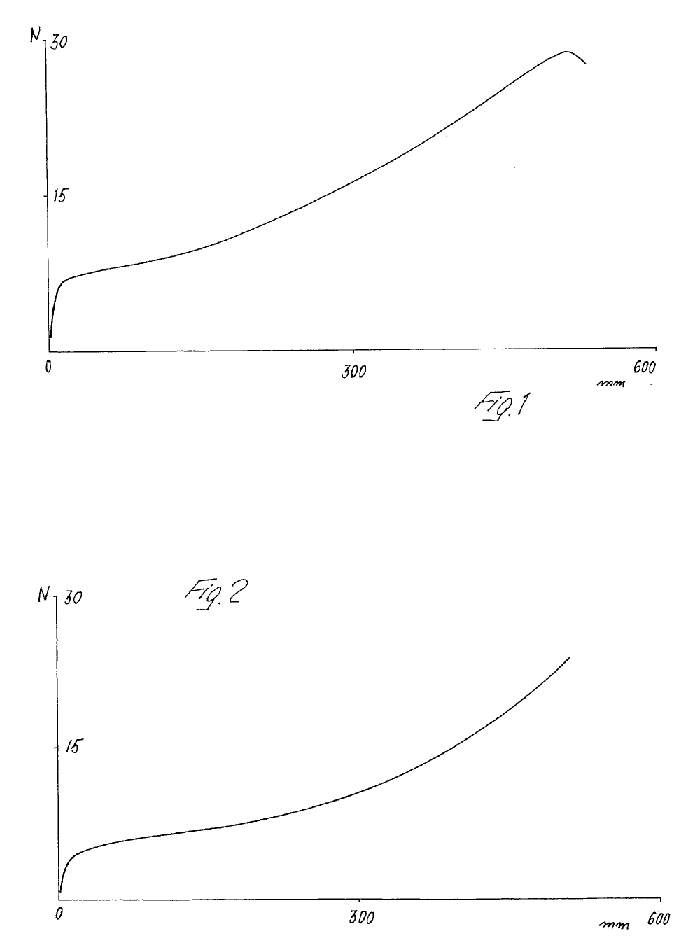

FIG. 1 is diagram showing a mechanical property of a first embodiment of the film according to the present invention; and

FIG. 2 is a diagram showing the same mechanical property of a second embodiment of the film according to the present invention.

As it is above discussed, the film, which is intended to be provided according to the present invention, is realized so as to be extremely versatile in packaging operations, particularly with the food products. The variety of the performances provided is rather wide, from the point of view of the permeability to the gases; consequently, it is necessarily required that some properties of the used resins have to be substantially superimposable, so as to allow the use of different kinds of packaging into the same production cycle. This differentiation takes place principally relating to the central layer of the film; the said layer will thus show balanced properties in respect of the kind of behaviour with the gases that is required for a given film.

Nevertheless, the properties of thermal sensitivity, that is to say the temperature of the glass transition, and the properties of longitudinal strain, which directly involve the construction of the package, as well as the properties of necking, of longitudinal thermo-shrinkage, of residual elastic memory, and also the optical properties, which result from the construction of the package, have to be as most homogenous as possible for the film as a whole.

The glass transition temperature in the range from 20° C. to 70° C. and the 200% strain at temperatures in the range from 20° C. and 45° C. with loads lower than 0.5 N/mm allow to perform packaging in a relatively simple way; the thermo-shrinkage and the necking allow a perfect adherence of the film to the package, if they are comprised in the respective ranges as defined according to the invention. A the same time, the residual elastic memory lower than 0.05 N/mm afford the fact that the film does not critically affect the shape of the package. Finally, the optical parameters such as light transmission, opacity and gloss have to be highlighted, because the package have to fulfill particular aesthetical requirements which cannot be underrated by the skilled man. A film which would show a light transmission lower than 90%, an opacity higher than 5% and a gloss lower than 100 could be very difficultly used for the packaging of food products.

So as to enhance the behavioural homogeneity as above outlined, the external layers of the extensible multilayer film according to the invention are realized in a such way as to result substantially compatible with the requirements of all the materials that can be used for the central layer, and also with the overall properties of the same film.

For the above reasons, ethylene/α-olefins copolymers are chosen for the external layers, having a density≦0.918 g/cm³, and particularly comprised in the range from 0.880 and 0.918 g/cm³, by this way preferring the performances relating to strain and transparency, along with excellent weldability; among these copolymers, the polyolefinic plastomers obtained using the catalytic process known as “metallocene” or “single site” are preferred, especially those purchased by the Exxon Chemical under the trade name of EXACT™, by the Basf under the trade name of LUFLEXEN™, and by the Dow under the trade name of AFFINITY™.

The performances of the said external layers can be improved if are added ethylene/vinyl acetate copolymers (EVA), having VA in the range of 5-14%, to the ethylene/α-olefins copolymers, so as to offer better combination between elasticity and tightening strength, together with a better tear and perforation resistance.

For ensure the final performances of the multilayer, it is necessary to dose in the said external layers the presence of additives having specific functions; among the said additives, slip agents, antiblock agents and antifog agents.

The criteria of choice of the materials making up the adhesive layers are oriented to offer inner cohesion and to ensure acceptable specific adhesiveness, so as to prevent peeling off; the said choice is therefore hardly influenced either from the inherent parameters of the polymers, or from the specific operation conditions.

The nature of the components characterising the central layer becomes determining for the choice of an appropriated bonding layer; for this reason, in addition to LLDPE modified with polar groups, ethylene vinyl acetate terpolymers or eventually ethylene acrylate resins modified with maleic anhydride can be preferred.

Two examples relating to the production of two different kind of films according to the present invention are reported as follows. In the examples, the external layer facing the environment is called “outer layer”, whilst the external layer facing the product is called “inner layer”

### EXAMPLE 1

A film provided with gas barrier properties according to the present invention has been produced, the said film being provided with a permeability to O₂≦100 cm³/m²*24 h*101.3 Kpa. Such a film is normally used for the packaging in protective atmosphere. Below are reported the features of the single layers composing the film.

Total thickness: 45 μm

Outer layer: 12 μm

Plastomers/m-LLDPE; d (density)=0.880-0.918 g/cm³; MI (melt index)=1-5 g/10 min, eventually with addition of slip agents and antiblocking agents.

(n-LLDPE; d=0.918 g/cm³ additioned with slip agents and antiblocking agents; MI=1 g/10 min)

Adhesive layer: 4 μm

LLDPE modified with maleic anhydride; d=0.90-0.94 g/cm³; MI=1-4 g/10 min

(LLDPE modified with maleic anhydride; d=0.91 g/cm³; MI=2.6 g/10 min)

Central layer: 10 μm

EVOH 38-47% C₂H₄; d=1.12-1.17 g/cm³; MI=1.5-5.5 g/10 min+plasticizer

(EVOH containing 38% mol of C₂H₄; d=1.17 g/cm³; MI=1.7 g/10 min+18 phr (part hundred resin) of 1,2-propanediol)

Adhesive layer: 4 μm

(LLDPE modified with maleic anhydride; d=0.91 g/cm³; MI=2.6 g/10 min)

Inner layer: 15 μm

Plastomers/m-LLDPE; d=0.880-0.918 g/cm³; MI=1-5 g/10 min, eventually with addition of antifog agents

(Polyolefinic plastomer; d=0.90 g/cm³; MI=1.7 g/10 min+1.8% antifog agent Antifog Loxiol A3 Cognis)

On a sample of the thus obtained film a longitudinal tensile test has been carried out. The sample was a sheet 100×25 mm, having 45 μm of thickness; a tensile strength has been applied to the sample at a temperature of 25° C. and at a speed of 500 mm/min. The results of the test are reported in FIG. 1 of the appended drawings; the diagram shows the relationship of the length of the sample with the tensile strength applied thereto. As it can be noted, the strain response of the film sample is extremely sensible even when the load applied are substantially small, and the film shows therefore the properties which are considered typical according to the present invention.

Below are reported the data of oxygen permeability obtained from a test carried out according to the standard ASTM D3985-95; the test relates samples of the film of the above example, longitudinally strained in the real use conditions in a packaging machine.

O₂ Permeability (cm³/m² × 24 h × atm)

| | After strain | After strain |
|---|---|---|
| Before strain | (theorical) | (experimental) |
| 5.7 | 15.2 | 11.1 |

On the experimental basis, it is therefore evident a significant recovery of the gas barrier effect in respect to the theoretical value, calculated taking into account only of the reduction of thickness of the film. The said recovery is due to the strain applied during the packaging stage, and to the consequent molecular orientation which increases the features of crystallinity of the plasticized barrier material.

The resulting packaging considerably improves the intrinsic properties of the material, ensuring high gas barrier values, also in the case of foodstuff having an high degree of relative humidity. Moreover, an excellent toughness and better performance in terms of perforation resistance are found for the film according to the invention.

### EXAMPLE 2

A gas permeable film has been used, provided with an oxygen permeability in the range from 2000 and 10000 cm³/m²*24 h*101.13 Kpa; the said film is typically used for the packaging of fresh foodstuff and of fruits and vegetables, according to the EMA (equilibrium modified atmosphere) technology. Below are reported the features of the single layers of the film.

Total thickness: 25 μm

Outer layer: 7 μm

Plastomers/m-LLDPE; d=0.880-0.918 g/cm³; MI=1-5 g/10 min+ethylene vinyl acetate copolymers (EVA, 5-14% VA), eventually with addition of slip agents and antiblocking agents.

(80% n-LLDPE, d=0.885 g/cm², MI=1.0 g/10 min; 20% EVA copolymer containing 9% VA, additioned with 2500 ppm of antiblocking and 750 ppm of erucamide)

Adhesive layer: 3 μm

Terpolymer ethylene vinyl acetate containing VA in a range from 13 to 20% by weight, d=0.940-0.945 g/cm³, MI=1.5-8 g/10 min.

(EVA containing 19% VA modified with polar groups, d=0.940 g/cm³)

Central layer: 5 μm

CoPA 6/12, 6/69+EVA copolymers (or eventually ethylene butil acrylate or ethylene metil acrylate) containing 5-28% VA).

(80% Copolyamide 6/12, 20% EVA copolymer containing 14% VA)

Adhesive layer: 3 μm

(Eva containing 19% VA modified with polar groups, d=0.940 g/cm³)

Inner layer: 7 μm

Plastomers/m-LLDPE; d=0.880-0.918 g/cm³; MI=1-5 g/10 min+ethylene vinyl acetate copolymers (EVA, 5-14% VA), with addition of antifog agents.

(80% n-LLDPE, d=0.885 g/cm², MI=1.0 g/10 min; 20% EVA copolymer containing 9% VA, +1.8% by weight of antifog agent Antifog Loxiol A3 Cognis).

On a sample of the thus obtained film a longitudinal tensile test has been carried out. The sample was a sheet 100×25 mm, having 25 μm of thickness; a tensile strength has been applied to the sample at a temperature of 25° C. and at a speed of 500 mm/min. The results of the test are reported in FIG. 2 of the appended drawings; the diagram shows the relationship of the length of the sample with the tensile strength applied thereto. Similarly to that it has been verified for the preceding example, also in this case the strain response of the film sample is extremely sensible, even when substantially small loads are applied.

The multilayer extensible film according to the present invention allows, owing to its strong characterization based upon the working specifications, the suitable adaptations which are required for each kind of product to be packaged.

1-18. (canceled)

19. Extensible multilayer film comprising two external layers made of thermoplastic polyolefinic resins, two optional intermediate adhesive layers and one central layer, characterized in that the said external layers are realized with ethylene/α-olefins copolymers resins, obtained by means of the technological process known as “metallocene” or “single site catalysis”, having a density≦0.918 g/cm³, and particularly comprised in the range from 0.880 and 0.918 g/cm³, and in mixture with ethylene/vinyl acetate copolymers, having a vinyl acetate content in the range from 5 to 14%, in an amount comprised between 0 and 40%, the said optional intermediate layers are realized with adhesive resins preferably containing linear low density polyethylene modified with polar groups, ethylene vinylacetate terpolymers, or maleic anhydride modified ethylene acrylate, and the said central layer comprises copolyamides 6/69, copolyamides 6/12 in mixture with ethylene vinyl acetate copolymers (EVA, 5-28% VA).

20. Extensible multilayer film according to claim 19, in which the said central layer comprises from 60% to 90% of copolyamide 6/12, and from 40% to 10% of EVA copolymer, containing from 10% to 20% of VA.

21. Extensible multilayer film according to claim 19, in which the said film has an overall thickness in the range of 17-60 μm, the thickness of the external layers being comprised between 5 and 18 μm, and that of the intermediate layers being comprised between 2 and 5 μm, whilst the thickness of the central layer is in the range from 3 and 14 μm.

22. Extensible multilayer film according to claim 20, in which the said film has an overall thickness in the range of 17-60 μm, the thickness of the external layers being comprised between 5 and 18 μm, and that of the intermediate layers being comprised between 2 and 5 μm, whilst the thickness of the central layer is in the range from 3 and 14 μm.

23. Extensible film according to claim 21, in which the external layer which has to face the product has a greater thickness in respect of the external layer facing the environment, and particularly can be from 30 to 50% more thick than the afore mentioned layer.
